(19) United States
(12) Patent Application Publication
(10) Pub. No.: US 2025/0303359 A1
(43) Pub. Date: Oct. 2, 2025

(54) COMPOUNDS AND METHODS FOR SAFE MITIGATION OF OCEAN ACIDIFICATION AND CAPTURE OF ATMOSPHERIC CARBON DIOXIDE

(71) Applicant: Negative Emissions Materials, Inc., Claymont, DE (US)

(72) Inventors: Jeremy LEY, Claymont, DE (US); David DREISINGER, Claymont, DE (US)

(21) Appl. No.: 18/841,280

(22) PCT Filed: Feb. 24, 2023
(86) PCT No.: PCT/US2023/063253

§ 371 Date: Aug. 23, 2024

Related U.S. Application Data
(60) Provisional application No. 63/314,013, filed on Feb. 25, 2022.

(51) Int. Cl. B01D 53/62; B01D 53/14; B01D 53/78

(52) U.S. Cl. CPC B01D 53/62; B01D 53/1475; B01D 53/1493; B01D 53/78; B01D 2251/402; B01D 2251/604; B01D 2252/1035; B01D 2257/504; B01D 2258/06

(57) ABSTRACT

The invention encompasses compositions and methods of sequestering atmospheric carbon dioxide (CO₂). In various embodiments, the invention compositions and methods to achieve ocean alkalinity enhancement in a way that is: (1) safe for the environment, (2) effective at counteracting seawater acidification, and (3) maximizes atmospheric CO₂ uptake and durable sequestration in the ocean. In embodiments, the invention provides compounds including, for example, magnesium hydroxide to achieve the above objectives and methods to distribute these compounds from both the perspective of physical handling and large scale delivery.

### I. CROSS-REFERENCE TO RELATED APPLICATIONS

This application claims the benefit of U.S. provisional application No. 63/314,013, which was filed on Feb. 25, 2022, and is hereby incorporated by reference in its entirety.

### II. FIELD OF THE INVENTION

The invention encompasses compositions and methods of sequestering atmospheric carbon dioxide (CO₂). In various embodiments, the invention includes compositions and methods to achieve ocean alkalinity enhancement in a way that is: (1) safe for the environment, (2) effective at counteracting seawater acidification, and (3) maximizes atmospheric CO₂ uptake and durable sequestration in the ocean. In embodiments, the invention provides inorganic hydroxide compounds including, for example, magnesium hydroxide, to achieve the above objectives and methods to distribute these compounds from both the perspective of physical handling and large scale delivery to the ocean.

### III. BACKGROUND OF THE INVENTION

Hundreds of gigatons of carbon dioxide (CO₂) will need to be sequestered from the atmosphere by the end of the twenty-first century to keep global warming below 2° C. within the constraints of the global carbon budget. However, so far it is unclear if and how this could be achieved. The management of existing atmospheric carbon dioxide and ongoing carbon dioxide emissions is desired to mitigate against the increase in the global average temperature and to reduce the effects of climate change. To realistically achieve this, about 10 to 20 gigatons (Gt) of CO₂ per year have to be removed from the atmosphere demanding carbon management strategies that can be implemented at a large scale.

The environmental effects of CO₂ are of significant interest. CO₂ is commonly viewed as a greenhouse gas. Because human activities since the industrial revolution have rapidly increased concentrations of atmospheric CO₂, anthropogenic CO₂ has been implicated in global warming and climate change, as well as ocean acidification.

Concerns over anthropogenic climate change and ocean acidification, compounded with recent changes in U.S. Federal policy to include carbon dioxide (CO₂) as a regulated air pollutant, have fueled an urgency to discover scalable, cost effective, methods of carbon capture and sequestration (CCS). Typically, methods of CCS separate pure CO₂ from complex flue streams, compress the purified CO₂, and finally inject it into underground saline reservoirs for geologic sequestration. These multiple steps are very energy and capital intensive.

The present inventors have identified compositions and methods to achieve ocean alkalinity enhancement in a way that: (1) is safe for the environment, (2) is effective at counteracting seawater acidification, and (3) maximises atmospheric CO₂ uptake and durable sequestration in the ocean.

### IV. SUMMARY OF THE INVENTION

The invention encompasses systems and methods that enhance the direct air capture of excess atmospheric CO₂ into the ocean in which CO₂ passively diffuses into the ocean. Much of that CO₂ is quickly hydrated to form carbonic acid. Carbonic acid dissociates into bicarbonate ions (HCO₃⁻) and protons (H⁺), the latter causing seawater to become more acidic. A proportion of the extra protons combines with carbonate ions (CO₃²⁻) to form HCO₃⁻; therefore increasing the concentration of HCO₃⁻ decreases CO₃²⁻ in seawater. The ocean typically absorbs 25-30 percent of the CO₂ that is released in the atmosphere, and as levels of atmospheric CO₂ increase, so do CO₂ and acidity levels in the ocean.

The invention generally encompasses systems and methods for sequestering CO₂ from the atmosphere by addition of an alkali hydroxide to discrete areas of the ocean, which has the effect of increasing the maximum amount and accelerating the time for uptake of CO₂ by oceans. The inventors have found that adding the compositions of the invention to the ocean has the effect of enhancing the alkalinity of seawater and provides a vast, naturally occurring and stable carbon storage medium for anthropogenic CO₂.

The invention generally encompasses new methods and compositions for extracting, reducing, capturing, disposing of, sequestering, or storing CO₂ or removing excess CO₂ from the atmospheric air, as well as new methods and compositions for reducing, alleviating, or eliminating CO₂ in the air, and/or the emissions of CO₂ to the air. One approach of managing atmospheric emissions is through a chemical process known as ocean alkalinity enhancement, by which CO₂ is removed directly from the atmosphere into the ocean.

In one embodiment, the invention encompasses a composition comprising an inorganic hydroxide, wherein the inorganic hydroxide is present in the composition in an amount of about 50% to about 99%, and wherein the inorganic hydroxide has a particle size of about 10 to about 20 microns, and wherein at least 80% of the particles have a size distribution in this range.

In certain embodiments, the inorganic hydroxide is lithium hydroxide, sodium hydroxide, potassium hydroxide, magnesium hydroxide, calcium hydroxide, or combinations thereof.

In certain embodiments, the inorganic hydroxide is a powder. In other embodiments, the inorganic hydroxide is a paste.

In certain embodiments, the paste further comprises 50% water.

In certain embodiments, the water is brackish water.

In certain embodiments, the water is sea water.

In certain embodiments, the amount of inorganic hydroxide in the paste is at least 50% (w/w). In certain embodiments, the amount of inorganic hydroxide is at least 60% (w/w). In certain embodiments, the amount of inorganic hydroxide is at least 70% (w/w). In certain embodiments, the inorganic hydroxide is a paste, wherein the inorganic hydroxide is present in an amount of about 50% (w/w), and wherein the paste further comprises about 50% water.

In another embodiment, the invention encompasses a composition comprising magnesium hydroxide (Mg(OH)₂) in an amount of about 50% to about 99% Mg(OH)₂, wherein the Mg(OH)₂ has a particle size of about 10 to about 20 microns, and wherein at least 80% of the particles have a size distribution in this range.

In certain embodiments, the Mg(OH)₂ is a powder. In other embodiments, the Mg(OH)₂ is a paste.

In certain embodiments, the paste further comprises 50% water.

In certain embodiments, the water is brackish water.

In certain embodiments, the water is sea water.

In certain embodiments, the amount of Mg(OH)₂ in the paste is at least 50% (w/w). In certain embodiments, the amount of Mg(OH)₂ is at least 60% (w/w). In certain embodiments, the amount of Mg(OH)₂ is at least 70% (w/w).

In certain embodiments, the Mg(OH)₂ is a paste, wherein the Mg(OH)₂ is present in an amount of about 50% (w/w), and wherein the paste further comprises about 50% water.

In another embodiment, the invention encompasses a method of extracting or capturing carbon dioxide from the atmosphere comprising:
adding an inorganic hydroxide to a defined area of the ocean at an injection rate of about 100 kg to about 1000 kg/s to generate a hydroxide concentration of about 5 mg/L to about 50 mg/L after 10 hours.

In another embodiment, the invention encompasses a method of extracting or capturing carbon dioxide from the atmosphere without causing ecotoxicity comprising:
adding an inorganic hydroxide to a defined area of the ocean at an injection rate of at least 1 T/s to generate a hydroxide concentration of about 5 mg/L to about 50 mg/L.

In another embodiment, the invention encompasses a method of extracting or capturing carbon dioxide from the atmosphere without causing ecotoxicity comprising adding an inorganic hydroxide to a defined area of the ocean at an injection rate is below the threshold to cause ecotoxicity. In certain embodiments, the threshold to cause ecotoxicity is a concentration of greater than 25 mg/L.

In certain embodiments, the inorganic hydroxide is lithium hydroxide, sodium hydroxide, potassium hydroxide, magnesium hydroxide, calcium hydroxide, or combinations thereof.

In certain embodiments, the inorganic hydroxide is Mg(OH)₂.

In certain embodiments, the Mg(OH)₂ is a paste.

In certain embodiments, the Mg(OH)₂ has a particle size of about 10 microns to about 50 microns.

In certain embodiments, the Mg(OH)₂ has a particle size of about 15 microns to about 25 microns.

In certain embodiments, the injection rate is about 0.1 T/s to about 5 T/s.

In certain embodiments, the injection rate is about 2.5 T/s.

In certain embodiments, the concentration of Mg(OH)₂ in the ocean is maintained for a period of about 1 hour to about 50 hours.

In certain embodiments, the concentration is maintained for a period of about 1 hour to about 50 hours.

In certain embodiments, the concentration is maintained for a period of about 5 hour to about 10 hours.

In certain embodiments, the inorganic hydroxide remains within about 100 m of the ocean surface.

In certain embodiments, the inorganic hydroxide remains within about 75 m of the ocean surface.

In certain embodiments, the inorganic hydroxide remains within about 60 m of the ocean surface.

In certain embodiments, the inorganic hydroxide is approximately 90% or greater purity.

In certain embodiments, the inorganic hydroxide is approximately 95% or greater purity.

In certain embodiments, the inorganic hydroxide is approximately 98% or greater purity.

In certain embodiments, the Mg(OH)₂ has no ecotoxicity effect.

In certain embodiments, the paste comprises about 50% seawater and 50% Mg(OH)₂.

### V. BRIEF DESCRIPTION OF THE FIGURES

FIG. 1A and FIG. 1B illustrate an exemplary hydrated paste of magnesium hydroxide having a homogenous and on average lower particle sizes in particular reducing the % of >10 micron particles.

FIG. 2 illustrates an exemplary graph plotting the settling rate against the remaining portion of suspended solids in the column for a hydrated paste of magnesium hydroxide.

FIG. 3 illustrates a graph showing the carbon chemistry of seawater is governed mostly by the pH, wherein an increase in the pH results in more CO₂ drawn down from the atmosphere.

FIG. 4 illustrates a graph showing survival of marine algae Tetraselmis suecica six days after 1-3-5-7-10-12-16-20-24 hours of exposure to 100 g/L of Mg(OH)₂ prior to dilution to 10 mg/L of Mg(OH)₂.

FIG. 5 illustrates daily regrowth of Tetraselmis suecica after 1 hour exposure to 100 g/L Mg(OH)₂ compared to 200 g/L of NaOH or 100 g/L of Ca(OH)₂ with the respective control waters without alkaline mineral.

FIG. 6 illustrates variation of the maximum pH observed in seawater after addition of 14-135 mg/L Mg(OH)₂ after full mixing (e.g., 2-4 hours at 300 rpm).

FIG. 7 illustrates increase in pH during the 30 first minutes of mixing (300 rpm) for different high Mg(OH)₂ concentrations. The pH of the 0.05 g/L Mg(OH)₂ solution was still increasing with a pH of 9.04 after 115 minutes.

FIG. 8 illustrates the sinking rate (cm/min) of 333 mg/L of Mg(OH)₂ paste in seawater by measuring the variation of the remaining total suspended solids (SS) at different depths of the 1 meter high settling column (water volume of 30 L) with time.

FIG. 9 illustrates variation of total alkalinity (AT) in test waters of the 1 m³ closed tanks after addition of 100 g/L of Mg(OH)₂ (in paste form) immediately followed by 1000× dilution to 100 mg/L, followed by 7× dilution after 1.5 hours of mixing to ˜14 mg/L (over a 4.5 hour period), and finally a 14× dilution to ˜1 mg/L (over a 4.5 hour period). The total alkalinity observed after 12 h of experiments (after completion of the last dilution step) stayed stable (and above the alkalinity in control water) until the end of the experiment (2-6 days) with continuous mixing during the entire experiment.

FIG. 10 illustrates variation of the dissolved inorganic compounds (CT) in test waters of the 1 m³ closed tanks after addition of 100 g/L of Mg(OH)₂ (in paste form) followed by dilutions as described in FIG. 9.

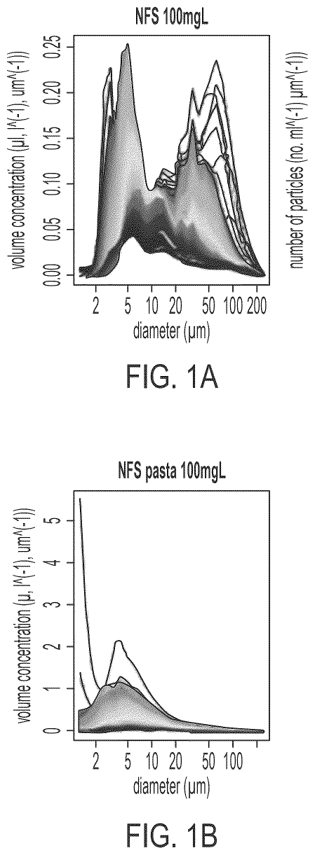

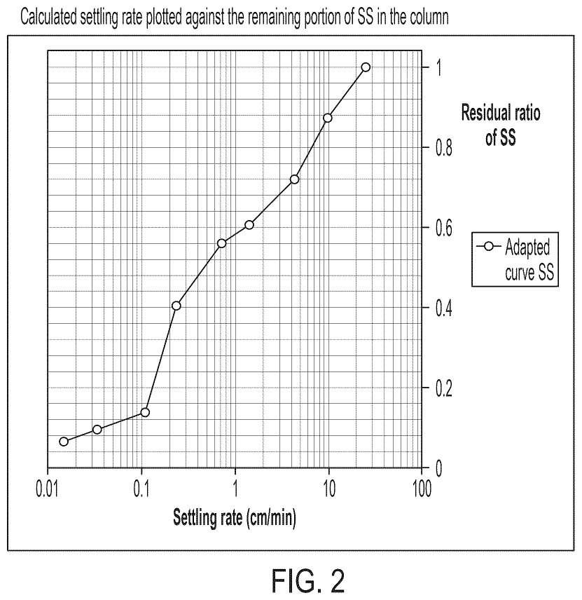

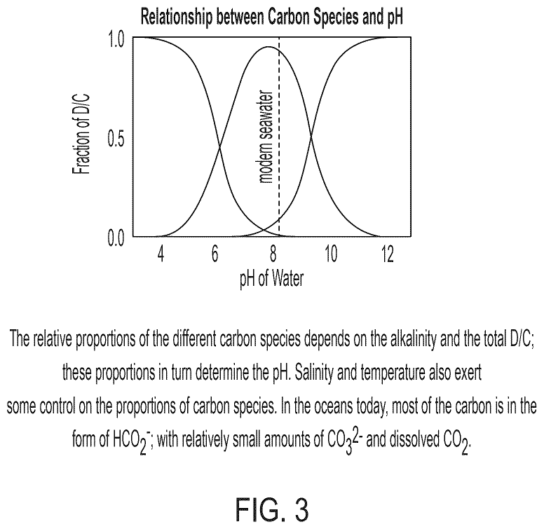

### VI. DETAILED DESCRIPTION OF THE INVENTION

### Definitions

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As used herein, the term “carbon capture” includes any process for capturing carbon dioxide, whether from the atmosphere or from a smokestack or other concentrated source of carbon dioxide emissions.

As used herein, the term “carbon capture and sequestration” refers to the process of capturing carbon dioxide emissions from a point-source, such as the flue of a gas-fired power plant, and injecting the captured carbon dioxide into geological reservoirs.

The terms “CO₂ sequestration” and “CO₂ capture” are defined herein and are used interchangeably and refer to the removal or capture of an amount of CO₂ from an environment, such as the Earth's atmosphere, so that some of the CO₂ is no longer present in the environment from which it has been removed. CO₂ capture methods of the invention sequester or capture CO₂ through the addition of alkaline hydroxides to localized areas of the ocean such that the CO₂ is sequestered.

As used herein, the term “carbon drawdown” is used as a synonym for carbon removal. It sometimes refers specifically to the use of carbon removal to reduce the atmospheric concentration of carbon dioxide, as opposed to simply slowing its increase.

As used herein, the term “carbon neutral” describes a country, company, process, etc., that does not emit more carbon dioxide than it captures. An entity could be carbon neutral because it does not emit any carbon dioxide in the first place, but “carbon neutral” more often refers to an entity or process that emits some carbon dioxide but removes just as much carbon dioxide from the atmosphere via carbon removal.

As used herein, the term “carbon removal” is the two-step process of capturing carbon dioxide (CO₂) from the atmosphere and locking it away for decades or centuries in oceans.

As used herein, the term “direct air capture” (DAC) is a process of capturing carbon dioxide directly from the ambient air (as opposed to capturing from point sources, such as a factory or biomass power plant) using specially designed techniques, for example, inorganic hydroxide compounds of the invention that capture with carbon dioxide from the air.

As used herein, the term “ecotoxicity” refers to at least one adverse effect on the environment and the organisms living in it, such as fish, wildlife, insects, plants and microorganisms caused by a composition of the invention.

### DESCRIPTION OF THE EMBODIMENTS

The oceans contain about 38,000 gigaton of CO₂, some 45 times more than the present atmosphere, and oceanic uptake has already consumed close to 40% of anthropogenic CO₂ emissions. On long timescales the ocean and weathering will reduce atmospheric CO₂ to values close to preindustrial levels. So the issue is not capacity, but rather a question of how to accelerate oceanic uptake and storage in a safe and cost-effective way.

Storage of CO₂ by increasing ocean alkalinity requires the extraction, processing, and dissolution of minerals. This results in chemical transformation of CO₂ and sequestration as bicarbonate and carbonate ions (HCO₃⁻ and CO₃²⁻) in the ocean. Dissolution of a mole of Ca²⁺ or Mg²⁺ sequesters close to 2 mol of CO₂. So even dissolution of carbonate minerals (e.g., CaCO₃), which contain a mole of C leads to some drawdown of CO₂.

The inventors have surprisingly found that if CO₂-reactive forms of alkalinity (e.g., the hydroxide compositions of the invention) are added to sea water, they rapidly react with seawater CO₂ to largely form non-CO₂-reactive bicarbonates, the primary form of seawater alkalinity. Because such reactions consume acidity (CO₂), seawater pH is thus elevated, as is carbonate saturation state. Additionally, the chemical conversion of seawater CO₂ to alkaline bicarbonate means that the pCO₂ of the water declines. As seawater is in constant contact with the atmosphere, when its pCO₂ drops below that of the atmosphere, air CO₂ spontaneously diffuses into the water until air/seawater pCO₂ and chemistry equilibrium is reached. The net effect is that CO₂ is removed from the atmosphere to the ocean, while seawater alkalinity, pH, carbonate saturation state, and inorganic carbon concentrations are higher than they were initially.

In addition, dramatic changes in seawater alkalinity are not needed to restore mean seawater pH and carbonate saturation state to pre-industrial values. Moreover, adding non-CO₂-reactive alkalinity (soluble bicarbonate bases equilibrated with air) to seawater does all of the preceding while having little or no direct effect on seawater pCO₂ or air CO₂ removal.

Once the newly alkalized seawater is equilibrated with the atmosphere, the bicarbonate (and some carbonate) ions formed simply enter the existing, large reservoir of these compounds in the ocean, where estimated residence times are near 200,000 years. Ultimately, they are removed from seawater via biological formation of solid calcium carbonate (shell formation) that precipitates nearly half of the carbon to the sea floor while the rest returns to the ocean/atmosphere system.

Accordingly, the invention generally encompasses systems and methods for capturing CO₂ from the atmosphere by addition of an alkali hydroxide to areas of the ocean, which has the effect of accelerating the time for uptake of CO₂ by oceans.

In certain embodiments, the invention encompasses accelerating the capture of CO₂ into seawater, which follows the following reaction:

CO₂+H₂O←→H₂CO₃←→HCO₃⁻+H⁺←→CO₃²⁻+2H⁺

A shift of the chemistry equilibrium toward HCO₃⁻ and CO₃²⁻ would coincide with decreasing the CO₂ concentration so that additional CO₂ from the atmosphere could be absorbed and stored permanently. Such a shift toward HCO₃⁻ can be induced through the addition and dissolution of hydroxide ion containing inorganic hydroxide compounds including for example lithium hydroxide, sodium hydroxide, potassium hydroxide, magnesium hydroxide, calcium hydroxide, or combinations thereof.

Accordingly, the invention encompasses systems and methods of sequestering CO₂ (i.e., CO₂ capture processes, methods, protocols, etc.) that result in CO₂ sequestration by the ocean based on localized increases in alkalinity through the addition of compositions of the invention including, but not limited to, lithium hydroxide, sodium hydroxide, potassium hydroxide, magnesium hydroxide, calcium hydroxide, or combinations thereof.

### Compositions of the Invention

The compositions of the invention are generally basic pH inorganic hydroxide compositions that when added to the ocean reduce acidification and thereby increase the amount of atmospheric CO₂ absorption by the ocean.

The compositions of the invention generally include alkali metal hydroxides or alkaline earth metal hydroxides. Exemplary embodiments of alkali metal hydroxides or alkaline earth metal hydroxides that can be included in the compositions of the invention include, but are not limited to, lithium hydroxide, sodium hydroxide, potassium hydroxide, magnesium hydroxide, calcium hydroxide, or combinations thereof. In other embodiments, the compositions of the invention can also include ammonium hydroxide. The above hydroxide compounds are collectively referred to herein as a hydroxides compounds of the invention.

The hydroxide compounds of the invention include lithium hydroxide, sodium hydroxide, potassium hydroxide, magnesium hydroxide, calcium hydroxide, or combinations thereof and are generally formed as a powder or paste. In certain embodiments, the hydroxide compounds of the invention are generally formed as a paste. The pastes of the invention can be formed by dissolving a hydroxide compound of the invention in ocean sea water. In various embodiments, the amount of the hydroxide of the invention in the paste can include about 10%, 15%, 20%, 25%, 30%, 35%, 40%, 45%, 50%, 55%, 60%, 65%, 70%, 75%, 80%, 85%, or 90% (w/v). In embodiments, the amount of hydroxide of the invention is 50% dissolved in 50% sea water. In another embodiment, compositions include a paste comprising magnesium hydroxide (i.e., Mg(OH)₂) in an amount of about 50% by weight dissolved in sea water.

In various embodiments, the paste can include the hydroxide compounds of the invention, for example, lithium hydroxide, sodium hydroxide, potassium hydroxide, magnesium hydroxide, calcium hydroxide, or combinations thereof having a particle size of about 0.1 micron to about 100 microns, or about 1 micron to about 50 microns, or about 10 microns to about 30 microns, or from about 15 microns to about 20 microns. In various embodiments, about 10% of the total particles in the composition have a particle size within the specified range, other embodiments, about 20%, 30%, 40%, 50%, 60%, 70%, 80%, 90%, 95%, 98%, Or 99% of the total particles in the composition have a particle size within the specified range. In specific embodiments, the compositions have a particle size of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100 microns. In embodiments, about 10%, 20%, 30%, 40%, 50%, 60%, 70%, 80%, 90%, 95%, or about 99% of the total particles in the composition have a particle size within the specified value.

In a specific embodiment, a composition of the invention comprised a magnesium hydroxide paste with a particle size of about 15 to about 20 microns, wherein about 80% of the particles are distributed within this range.

It has been found that the ocean alkalinization and carbon capture process can be accelerated up by increasing the reactive surface area of such the compositions to increase dissolution rate and placing them in the ocean.

### Delivery and Concentrations in Ocean

Achieving appropriate concentrations and maximum of compositions of the invention is critical to avoid negative consequences to the ocean ecosystem including ecotoxicity.

The CO₂ capture methods of the invention are based on a proprietary ocean alkalinity enrichment protocol mediated methods. By ocean alkalinity enrichment protocol mediated methods is meant that the methods employ an alkali enrichment protocol at some point during the method, e.g., to produce a CO₂ capture ocean alkalinity composition. The ocean alkalinity enrichment protocol may be employed once or more times.

In various embodiments, the compositions of the invention can be delivered in the open ocean, coastal areas (e.g., within about 3 miles of the shoreline), or coastal estuaries (e.g., brackish waters that lead into the ocean). In embodiments, the compositions of the invention are delivered to the open ocean.

In various embodiments, the concentration of the composition of the invention including lithium hydroxide, sodium hydroxide, potassium hydroxide, magnesium hydroxide, calcium hydroxide, or combinations thereof can be delivered to the ocean to deliver a concentration of, for example, about 0.1 mg/L to about 50 mg/L, or about 1 mg/L to about 30 mg/L, or from about 5 mg/L to about 25 mg/L, or from about 10 mg/L to about 20 mg/L for a period of about 5 to about 10 hours. Additional compositions of the invention may be added to the ocean to maintain the concentration in ocean for the desired amount of time.

In certain embodiments, the concentration of the composition of the invention including, but not limited to, lithium hydroxide, sodium hydroxide, potassium hydroxide, magnesium hydroxide, calcium hydroxide, or combinations thereof are delivered to the ocean at a concentration of about 0.1, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or about 50 mg/L.

The compositions of the invention are intended to deliver a composition including an amount of inorganic hydroxide including sodium hydroxide, potassium hydroxide, magnesium hydroxide, calcium hydroxide, or combinations thereof in an concentration that avoids overdosing (e.g., concentrations of greater than 25 mg/L) and avoids ecotoxicity. The inventors have surprisingly found that magnesium hydroxide possesses better safety characteristics (e.g., reduced ecotoxicity) at higher concentrations than for example, sodium hydroxide or calcium hydroxide. The use of magnesium hydroxide in the compositions and methods of the invention was surprisingly found to have no overdosing effect. For example, compositions including magnesium hydroxide when distributed in the ocean resulting in concentrations of 100 g/L for 5 hours showed no ecotoxicity effect. In contrast, the use of sodium hydroxide or calcium hydroxide at concentrations of greater than 25 mg/L resulted in ecotoxicity.

The inventors have further surprisingly found that it is not critical to maintain high sea concentrations of the inorganic hydroxides of the invention for long periods of time to achieve maximum carbon capture, but rather fast distribution with high dissolution that avoids overdosing results in maximal carbon capture.

In specific embodiments, achieving concentrations within ecosystem safety limits near or above stoichiometrically expected atmospheric CO₂ uptake occurs within about 7 days. In certain embodiments, about 3 to about 9% of the effect occurs within 24 hours and the full effect occurs by day 6. In certain embodiments, up to 25 mg/L concentration increases of Mg(OH)₂, after 6 days, exhibit about 90% to about 200% of the CO₂ uptake expected from stoichiometry.

The compositions of the invention can be delivered to the ocean to achieve the desired concentration at various injection rates. In various embodiments, the compositions can be delivered to the ocean, for example, by pumping the compositions from land into the ocean or by injection from ships, (e.g., merchant ships).

In various embodiments, the composition of the invention can be delivered into the ocean at a rate of about 100 kg/s, 500 kg/s, 0.1 t/s (ton/second), 1, 2, 3, 4, 5, 6, 7, 8, 9, or about 10 t/s. In certain embodiments, the composition of the invention can be delivered into the ocean at a rate of about 1 t/s. In other embodiments, the composition of the invention can be delivered into the ocean at a rate of about or about 2.5 t/s. In exemplary embodiments, an injection rate of about 850 kg/s leads to concentrations of 25 mg/L of Mg(OH)₂ after 10 hours.

In various embodiments, modelling has shown disbursement of the compositions of the invention in ocean water occurs at relatively consistent rate. In various embodiments, the compositions of the invention have an approximate sinking rate of about 0.1 m/day, 1, 2, 3, 4, 5, 6, 7, 8, 9, or about 10 m/day.

In various embodiments, greater than 50%, 60%, 70%, 80%, 90%, 95%, 96%, 97%, 98%, or 99% of the composition of the invention remains within about the 10 m, 20, 30, 40, 50, 60, or about 70 m of the ocean surface within about 10 days.

In a specific embodiments, magnesium hydroxide (Mg(OH)₂) when added to sea water rapidly reacts with CO₂, forming dissolved bicarbonate (Mg²⁺+2HCO₃⁻) and, to a lesser extent, dissolved magnesium carbonate ions (Mg²⁺+CO₃²⁻). The net result is that magnesium hydroxide (or any of the disclosed hydroxides) addition to seawater increases the removal of excess CO₂ from the ocean/atmosphere system and stores this carbon in a stable, dissolved bicarbonate/carbonate alkalinity. This simply adds to the existing, vast global carbon pool of these alkaline compounds in the ocean, by far the largest single carbon reservoir on the Earth's surface.

Depending on the amount of hydroxide composition added and the initial seawater pCO₂, the water would either take up CO₂ from the atmosphere or degas less until equilibrium is restored, hence acting as a sink for atmospheric CO₂. In various embodiments, the inventors found that about 1.5 moles of atmospheric CO₂ could be taken up per mole of Mg(OH)₂ or Ca(OH)₂. Furthermore, dissolving, for example, Mg(OH)₂ or Ca(OH)₂ can also counteract ocean acidification in two ways, raising the pH of seawater and raising the carbonate saturation state by increasing both dissolved [Ca²⁺] and [CO₃²⁻]. Therefore, the claimed ocean alkalinity compositions and methods are a dual solution for both removing CO₂ from the atmosphere and changing ocean acidification trajectories.

### VII. EXAMPLES

### Example 1

Experimental work on seawater shows that achieving Mg(OH)₂ concentrations within ecosystem safety limits achieve near or above stoichiometrically expected atmospheric CO₂ uptake, with only 3 to 9% of the effect occurring within 24 hours and the full effect having occurred by day 6.

Alkalinity and carbon content are maintained at 50 mg/L or more Mg(OH)₂ concentrations for several days leads to net negative effect Mg(OH)₂ additions on the alkalinity and carbon content, probably via a secondary precipitation effect due to the elevated pH conditions.

Day 0 results from bioassays experiments on AT/CT, show for all 10 mg/L treatments a positive 3 to 9% uptake of CO₂ of the effect expected from stoichiometry.

Up to 25 mg/L concentration increases of Mg(OH)₂, after 6 days, appear to have 90%-200% of the CO₂ uptake expected from stoichiometry.

Samples that were first exposed to 1 to 100 g/L for 1 to 5 hours and then diluted to 10 mg/L also have a CO₂ uptake in line or above those expected from stoichiometry, which seem to confirm that an initial negative effect on AT/CT from high concentration of Mg(OH)₂ is more than reversed with dilution & time

Magnesium hydroxide paste with 15 to 20 micron p80 particle size maximises atmospheric CO₂ uptake by minimising the share of reagent sinking below the well mixed layer.

Modelling based on 6 m/day sinking rate maintains 97% of the Mg(OH)2 within the top 60 m of the ocean.

The approximate 6 m/day for the small particles of about 10 micron in size based on 4 cm sinking within 10 minutes with LISST instrument is reassuring that optimised Mg(OH)₂ particles would remain in the well mixed layer and therefore deliver the expected CO₂ uptake.

Further test work shows that a paste made from 50% sea water and 50% magnesium hydroxide powder achieves slower settling rates. See drawings for sinking speed/mass fraction of the paste & the particle size distribution of the paste vs powder.

### Example 2

To avoid the known ecosystem toxicity risks of trace metals and silica the invention uses only pure hydroxides (98%+)

Tests for growth inhibition of hydroxide additions equivalent to 100, 10 and 1 mg/L Mg(OH)₂, NaOH and Ca(OH)₂ on Tetraselmis suecica cultures grown in a medium of pasteurised 60 m SW and Z8 (20%) over a 6-day period showed that hydroxide additions equivalent to 1 and 10 mg/L of Mg(OH)₂ were not ecotoxic, whether done using Mg(OH)₂, NaOH or Ca(OH)₂.

Equivalents to 100 mg/L of Mg(OH)₂ by any of the three alkaline agents inhibits the growth of the culture algae.

UV blocking and the presence of inert particles failed to replicate this ecotoxicity effect. pH change is the assumed cause of this ecotoxicity. Hence this conclusion is presumed valid across hydroxides. Further investigation will attempt to confirm at larger scales and varying ecosystems these results.

Further standardized ecotoxicity work on Skeletonema pseudocostatum clarified that dosages of 25 mg/L Mg(OH)₂ showed no negative impact but dosages of 50 mg/L and upwards did.

### Example 3: Ecotoxicity Effect of Mg(OH)₂ on Aquatic Organism

a. Algal, Crustacean and Fish Toxicity Tests with 100 mg/L of Mg(OH)₂

Both the acute and chronic toxicity effect of up to 100 mg/L Mg(OH)₂ in seawater was tested on local marine algal and crustacean species and on freshwater fish embryos of a tropical species during both bench and pilot scale studies according to standard toxicity testing procedures. According to the results shown in Table 1, the lowest tested concentration of Mg(OH)2 showing some toxicity effect on aquatic organisms was 50 mg/L. No toxicity effect was observed at 25 mg/L Mg(OH)2 for any of the standard test organisms tested. These results were obtained from samples collected from the first 1 m³ scale experiment and confirmed the toxicity results observed in the bench scale experiments.

TABLE 1
Lowest observed effect concentration (LOEC) results from the toxicity
tests performed by NIVA with solutions of 100 mg/L Mg(OH)2 mixed
as paste into local seawater (n = replicate tests).

| | | | LOEC |
|---|---|---|---|
| Toxicity Test Description | | Species Name | (mg/L) |
| Sub- | Marine algal growth inhibition | Skeletonema | 50 |
| Chronic | test, 72 h (n = 2) | pseudocastatum | |
| Acute | Marine copepod, acute toxicity | Tisbe battaglial | 100 |
| | test, 48 h (n = 1) | | |
| | Freshwater Fish embryo, growth | Danio rerio* | >100 |
| | test, 96 h (n = 1) | | |
| Chronic | Marine copepod, development test, | Tisbe battaglial | >100 |
| | 7 days (n = 1) | | |

*considered as tropical species as well.

### B. Short-Time Exposure of Marine Algae to 100 g/L Mg(OH)2

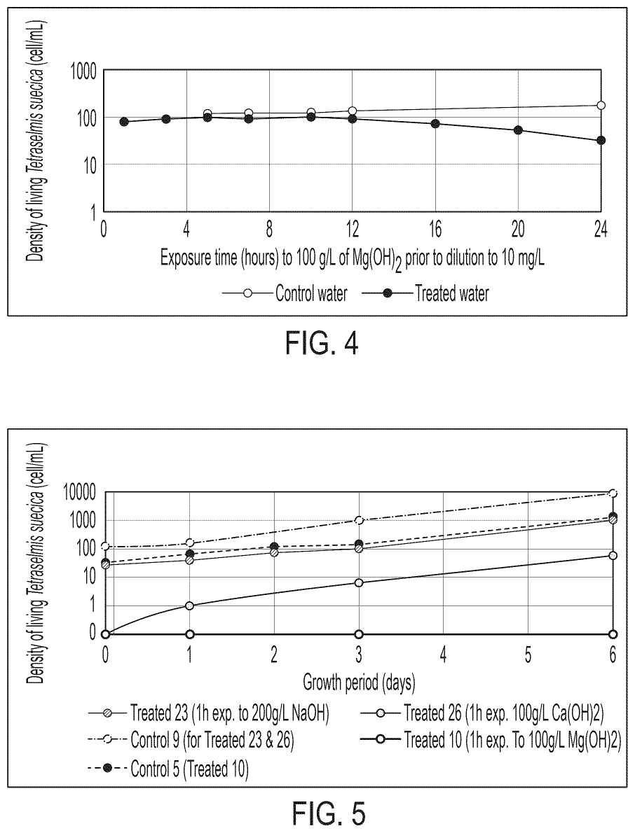

A total of 11 bench scale bioassays, including 32 treated water samples, were performed to study the survival rate of cultivated marine algae (Tetraselmis suecica) after short-term exposure to high concentration of Mg(OH)₂. As shown in FIG. 4 with the normalized results from three complementary and/or replicative separate tests, no mortality of the local marine algae Tetraselmis suecica could be observed, compared to the control water, for less than 10 hours of exposure to 100 g/L of Mg(OH)₂ prior to dilution to 10 mg/L of Mg(OH)₂.

C. Toxicity Comparison of Mg(OH)₂ to NaOH and Ca(OH)₂

The toxicity effect of two other alkaline minerals (Ca(OH)₂ and NaOH) was compared to Mg(OH)₂ by running similar bioassays to study the regrowth of Tetraselmis suecica after exposure of 1 hour to either 100 g/L Ca(OH) 2 or 200 g/L of NaOH or 100 g/L Mg(OH)₂. As shown in FIG. 5, no surviving cells could be observed in the samples treated with NaOH or Ca(OH)₂ immediately after dilution of the sample to 10 mg/L after 1 hour of exposure to the high concentrations, while no mortality was observed in the sample treated with Mg(OH)₂ compared to the control water sample (unamended) even after 6 days of culture. After six days of regrowth, still no surviving organisms could be observed in the sample treated with NaOH, while very few living cells could be seen in the sample treated with Ca(OH)₂ but in concentrations still significantly below to the corresponding control water.

### Example 4

### Mg(OH)2 Dissolution, Sinking Rate, and CO2 Capture

a. Dissolution Efficacy of Mg(OH)2 into Seawater

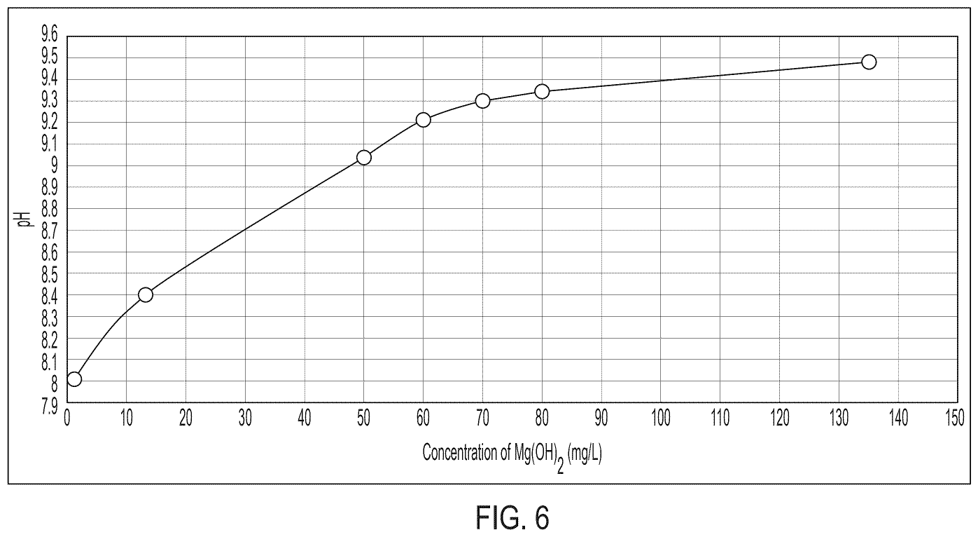

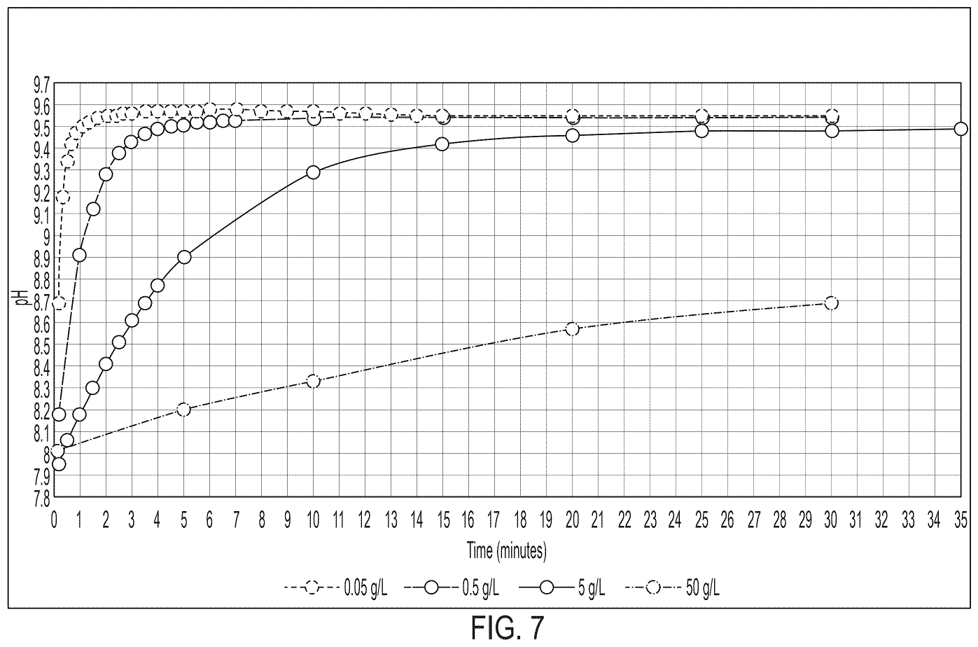

According to observations during laboratory experiments, the full dissolution of Mg(OH)₂ particles added into local 60 m deep seawater (pH=7.9-8.0) at approximately 22° C. was observed after approximately 3 hours of mixing (300 rpm with magnetic stirrer) for concentrations below to ˜10 mg/L. It was not possible to measure the concentration of dissolved Mg(OH)₂ into seawater with ICP/MS due to the natural high concentration of Mg2+ in seawater (>1 g/L). As shown in FIG. 6 and FIG. 7, both the maximum pH achieved (approaching ˜9.5) and the rate of increase of pH correspond to the concentration Mg(OH)₂.

B. Sinking Rate of Mg(OH)₂ into Seawater

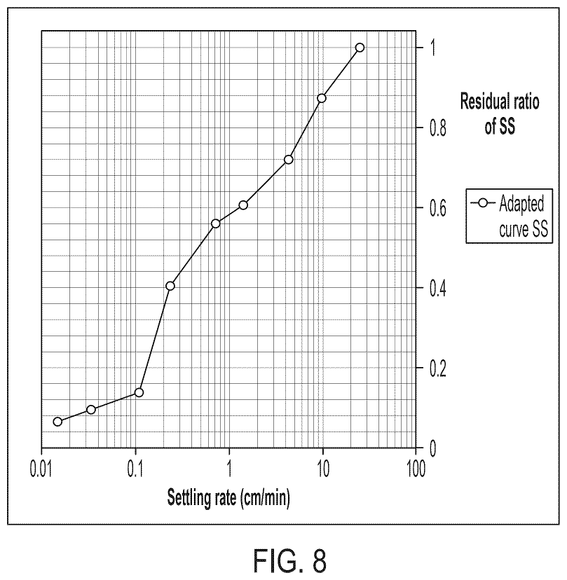

According to laboratory experiments:
When Mg(OH)₂ is added to seawater as powder, the particles are sinking quickly with a rate of 0.1 to 7.0 cm/min depending on the size of the particles that appear to aggregate in contact with water (i.e., ˜0.8-6 km/day for visible particles (i.e., >100 μm)).
When Mg(OH)₂ is added to seawater as paste, the particle size distribution was within 5-60 μm approximately, and the corresponding sinking rate is slow; within ˜0.015-25 cm/min or ˜0.2-360 m/day for particles above 0.7 μm (FIG. 8).
   C. Efficacy of the Mg(OH)₂ addition on the CO₂ Capture and Alkalinity Increase

According to the 1-6 days bench scale (i.e., 1-3 L water volume) experiments performed with deep local seawater (containing 400 ppm pCO₂ at 22° C.), an efficacy of approximately 1.5 mol CO₂ consumption (or alkalinity increase) per mol of Mg(OH)₂ added was calculated. Therefore, the efficacy was on average 77±8% (n=19) of the maximum theoretical stoichiometry for Mg(OH)₂ experiments (i.e., 2:1).

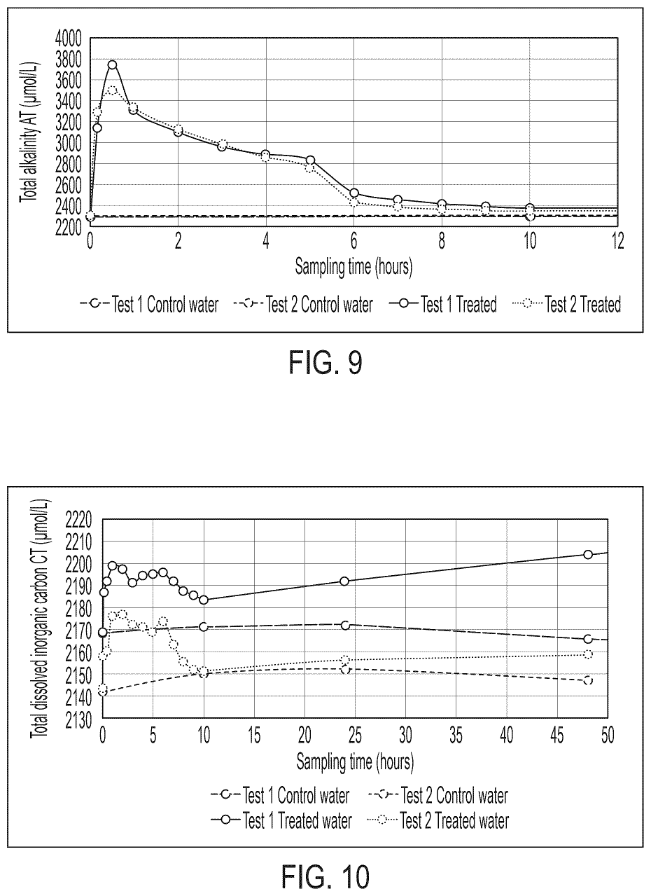

These observations were confirmed by the results from the 3-6 days of 1 m³ scale experiments (FIG. 9) performed with deep local seawater (containing 500-600 ppm pCO₂ at 8-15° C.), an efficacy average of 57-88% (n=2) of the maximum theoretical stoichiometry for Mg(OH)₂ was observed.

Two experiments at the 1 m³ scale were successfully carried out without massive loss of Mg(OH)₂ to CaCO₃ precipitation. The dilution steps used in the experiments (illustrated in the FIG. 9) were based on the model predictions of Mg(OH)₂ addition to seawater in front of a ship's propeller. The total dissolved inorganic carbon (CT) increase was observed to be about ½ of the total alkalinity (AT) increase (FIG. 10); this is due to the increase in CO₃ and HCO₃ (with COs resulting in a 2:1 increase in AT). However, the alkalinity results indicate that the final Mg(OH)₂ concentration (i.e., 1 mg/L) might have been significantly higher (i.e., 4-5 mg/L) than the theoretical concentration calculated from serial dilutions. This might be explained by the combination of the challenge of vertical mixing in the tank while emptying the tank from the top during serial dilutions as settling of particles was observed in the bottom in the first part of the experiment. At present, analytical methods are not sensitive enough to measure Mg at the range of 1-5 mg/L concentration when there is already 1,000-3,000 mg/L of Mg naturally in seawater. Therefore, Mg concentrations were inferred (indirectly) from increase in AT.

Those skilled in the art will recognize that the present invention may be manifested in a variety of forms other than the specific embodiments described and contemplated herein. Accordingly, departures in form and detail may be made without departing from the scope and spirit of the present invention as described in the appended claims.

What is claimed is:

1. A composition to increase atmospheric CO₂ uptake comprising an inorganic hydroxide, wherein the inorganic hydroxide is present in the composition in an amount of about 50% to about 99%, and wherein the inorganic hydroxide has a particle size of about 10 to about 20 microns, and wherein at least 80% of the particles have a size distribution in this range, and wherein the composition can achieve ocean alkalinity enhancement in a way that is: (1) safe for the environment, (2) effective at counteracting seawater acidification, and (3) maximizes atmospheric CO₂ uptake and durable sequestration in the ocean.

2. The composition of claim 1, wherein the inorganic hydroxide is lithium hydroxide, sodium hydroxide, potassium hydroxide, magnesium hydroxide, calcium hydroxide, or combinations thereof.

3. The composition of claim 1, wherein the inorganic hydroxide is formulated as a powder.

4. The composition of claim 1, wherein the inorganic hydroxide is formulated as a paste.

5. The composition of claim 4, wherein the paste further comprises 50% water.

6. The composition of claim 5, wherein the water is brackish water.

7. The composition of claim 5, wherein the water is sea water.

8. The composition of claim 1, wherein the amount of inorganic hydroxide at least 50% (w/w) of the total composition.

9. The composition of claim 1, wherein the amount of Mg(OH)₂ is at least 60% (w/w) of the total composition.

10. The composition of claim 1, wherein the amount of Mg(OH)₂ is at least 70% (w/w) of the total composition.

11. The composition of claim 1, wherein the inorganic hydroxide is formulated as a paste, wherein the inorganic hydroxide is present in an amount of about 50% (w/w), and wherein the paste further comprises about 50% sea water.

12. A composition comprising magnesium hydroxide (Mg(OH)₂) in an amount of about 50% to about 99% Mg(OH)₂, wherein the Mg(OH)₂ has a particle size of about 10 to about 20 microns, and wherein at least 80% of the particles have a size distribution in this range.

13. The composition of claim 12, wherein the Mg(OH)₂ is formulated as a powder.

14. The composition of claim 12, wherein the Mg(OH)₂ is formulated as a paste.

15. The composition of claim 14, wherein the paste further comprises 50% water.

16. The composition of claim 15, wherein the water is brackish water.

17. The composition of claim 15, wherein the water is sea water.

18. The composition of claim 12, wherein the amount of Mg(OH)₂ is at least 50% (w/w) of the total composition.

19. The composition of claim 12, wherein the amount of Mg(OH)₂ is at least 60% (w/w) of the total composition.

20. The composition of claim 12, wherein the amount of Mg(OH)₂ is at least 70% (w/w) of the total composition.

21. The composition of claim 12, wherein the Mg(OH)₂ is formulated as a paste, wherein the Mg(OH)₂ is present in an amount of about 50% (w/w) of the total composition, and wherein the paste further comprises about 50% water.

22. A method of extracting or capturing carbon dioxide from the atmosphere comprising:
adding an inorganic hydroxide to the ocean at an injection rate of about 100 kg/s to about 1000 kg/s to generate a hydroxide concentration of about 5 mg/L to about 50 mg/L after 10 hours.

23. The method of claim 22, wherein the inorganic hydroxide is lithium hydroxide, sodium hydroxide, potassium hydroxide, magnesium hydroxide, calcium hydroxide, or combinations thereof.

24. The method of claim 22, wherein the inorganic hydroxide is Mg(OH)₂.

25. The method of claim 22, wherein the inorganic hydroxide is formulated as a paste.

26. The method of claim 22, wherein the inorganic hydroxide has a particle size of about 10 microns to about 50 microns.

27. The method of claim 22, wherein the inorganic hydroxide has a particle size of about 15 microns to about 25 microns.

28. The method of claim 22, wherein the inorganic hydroxide remains within about 100 meters of the ocean surface.

29. The method of claim 22, wherein the inorganic hydroxide remains within about 60 m of the ocean surface.

30. The method of claim 22, wherein the inorganic hydroxide is approximately 90% or greater purity.

31. The method of claim 22, wherein the inorganic hydroxide is approximately 95% or greater purity.

32. The method of claim 22, wherein the inorganic hydroxide is approximately 98% or greater purity.

33. The method of claim 22, wherein the inorganic hydroxide has no ecotoxicity effect.

34. The method of claim 25, wherein the paste comprises about 50% seawater and 50% Mg(OH)₂.

35. A method of acerating the capture of atmospheric CO₂ by the ocean comprising delivering to the ocean a composition of claim 1.
